(19) United States
(12) Patent Application Publication
(10) Pub. No.: US 2022/0305743 A1
(43) Pub. Date: Sep. 29, 2022

(54) METHOD AND STRAND-DRAWING DEVICE FOR PRODUCING LEAF SPRINGS IN FIBER COMPOSITE CONSTRUCTION

(71) Applicant: KRAUSSMAFFEI TECHNOLOGIES GMBH, München (DE)

(72) Inventors: Erich Fries, Augsburg (DE); Wolfgang Hinz, Dachau (DE)

(21) Appl. No.: 17/270,975

(22) PCT Filed: Oct. 31, 2018
(86) PCT No.: PCT/EP2018/079811

§ 371 Date: Feb. 24, 2021

(30) Foreign Application Priority Data
Sep. 7, 2018 (DE) 10 2018 121 852.4

(51) Int. Cl. B29C 70/52

(52) U.S. Cl. CPC B29C 70/521; B29C 70/526; B29K 2075/00

(57) ABSTRACT

A method for producing leaf springs in fiber composite construction in a desired shape of the leaf springs, the method including the following steps: strand-drawing a fiber material from a fiber supply store into an injection box, which is designed to continuously impregnate a respective section of the fiber material within an injection chamber of the injection box under a chamber overpressure with at least one matrix material during the strand drawing of the fiber material; pulling the fiber material strand impregnated with the matrix material out of the injection box, and subsequently, conveying the fiber material strand impregnated with matrix material to a heating device, where each of the conveyed sections of the fiber material strand impregnated with the matrix material is at least partially cured; and forming the fiber material strand reinforced with the matrix material into the desired shape of the leaf springs. The invention further relates to an associated strand-drawing device.

The invention relates to a method for producing leaf springs in fibre composite construction into a desired shape of the leaf springs, and an associated strand-drawing device.

From EP 2 492 074 A1 a discontinuous method is known for the production of a leaf spring as a fibre composite component for a motor vehicle, which comprises individual fibres and a matrix of a cured resin surrounding the fibres, in which the fibres are prepared and layered on one another in the form of at least two textile layers, wherein the textile layers are formed within a press-moulding die and are fixed to a dry preform by a binding agent applied dry onto at least one of the textile layers, which preform is infiltrated in a RTM cavity with the resin and cured.

From U.S. Pat. No. 4,445,957 a continuous method is known for producing a leaf spring as a fibre composite component for a motor vehicle, which comprises individual fibres and a matrix of a cured resin surrounding the fibres. The leaf springs as fibre composite components are manufactured in a pultrusion device which comprises an open trough in which the fibres are impregnated with the matrix.

It is the object of the invention to create a method and a strand-drawing device, whereby leaf springs can be manufactured in fibre composite construction particularly efficiently and in high quality.

The problem is solved by a method for producing leaf springs in fibre composite construction into a desired shape of the leaf springs, comprising the steps:
strand-drawing a fibre material from a fibre supply store into an injection box, which is designed to continuously impregnate a respective section of the fibre material within an injection chamber of the injection box under a chamber overpressure with at least one matrix material during the strand drawing of the fibre material,
pulling the fibre material strand impregnated with the matrix material out of the injection box, and subsequently, conveying the fibre material strand impregnated with matrix material to a heating device, where each of the conveyed sections of the fibre material strand impregnated with the matrix material is at least partially cured, and forming the fibre material strand reinforced with the matrix material into the desired shape of the leaf springs.

Leaf springs are a specific type of construction of general springs, which allow themselves to be deformed elastically to a structurally particular extent owing to external forces which act on the leaf spring, wherein energy is stored in the elastically deformed leaf spring, which is released again on an elastic recovery of the leaf spring. Leaf springs are frequently used in vehicle construction, for example, in particular as component of a spring and damper arrangement of a chassis, on which the wheels of the vehicle are mounted. Generally, there is a need for a favourably priced serial production of such leaf springs in large quantities. Owing to the high requirements with regard to the structural maturity of the leaf springs, as low a weight as possible of the leaf springs and a secure use, for example also with regard to the crash behaviour of the leaf springs in the event of an accident with the vehicle, leaf springs are increasingly produced as fibre composite components.

Hitherto, such fibre composite components were produced inter alia either in individual manufacture piece by piece in special individual moulds, for example by manual inserting of fibre mats, which are impregnated with resin, into a mould and subsequent heating and pressing in the mould. Alternatively, such fibre composite components can also be produced continuously in continual quantities by the strand-drawing method. However, a use of an open bath, in which within the known strand-drawing method, which can also be designated as pultrusion method, only certain resins can be used procedurally, it is disadvantageous that no highly reactive and/or fast-reactive resins can be used. Also, a complete and homogeneous penetrating of the fibre material with the resin is not always guaranteed in an open bath.

According to the invention, it is therefore proposed to produce leaf springs by means of strand-drawing and namely with the use of an injection box with an injection chamber under overpressure, wherein subsequently in the injection box optionally a complete curing of the fibre material, impregnated with matrix material, can take place, or only a partial curing of the fibre material, impregnated with matrix material, can take place. Owing to an optionally complete or only partial curing, depending on the desired characteristics in the desired shape for the leaf springs, i.e. the three-dimensional configuration of the leaf springs, also after a partial curing, forming process steps follow additionally, in order to also be able to produce leaf springs which are to have a different shape than only a mere straight one. In particular, according to the invention, a desired shape of the leaf springs, differing from the mere straight configuration of the leaf springs can be produced by the continuous method, free of interruption and fully automatically.

The desired shape of the leaf springs comprises accordingly both the desired cross-section shape or respectively cross-section configuration of the leaf springs, which can be identical or else different in different cross-sections, and also the shape in longitudinal extent of the leaf springs, such as for example their curvature in the bending portion and their shapings at the end portions of the leaf springs, in particular with regard to the formation of fastening sites by which the leaf springs can be later fastened to the selected components, such as for example chassis connection points.

The fibre material can be individual threads or fibre bundles. The fibre material can, however, also be braided or woven strand material, such as for example strips. In particular, the fibre material can comprise glass fibres, carbon fibres, basalt fibres and/or aramid fibres. The fibre material is also designated inter alia as roving and in general denotes bundles or strands of filaments, i.e. endless fibres.

The fibre supply store serves for the storing of a sufficient quantity of fibre material for the continuous, interruption-free manufacture over an appropriate period of time. Generally, such fibre supply stores can be formed by spool frames, in which a plurality of spools, on which the fibre materials are wound, are rotatably mounted, so that the fibre materials can be easily drawn off. The drawn-off fibre materials are then conveyed to the injection box.

The injection box comprises an injection chamber into which the fibre materials are drawn, coming from the fibre supply store. Preferably a chamber overpressure prevails inside the injection chamber. The desired or respectively required matrix material is injected or respectively pressed in at high pressure into the injection chamber from outside the injection box. Owing to the high chamber pressure, the matrix material can penetrate particularly well into the intermediate spaces of the fibre materials and can connect in particular over the entire area and free of air inclusions, i.e. free of bubbles.

The matrix material can be, in particular, polymers. The matrix material can be thermosets, thermoplastics and/or elastomers. The matrix material can be reactively curing. Alternatively, the matrix material can be self-curing. The matrix material can therefore comprise, for example, polyurethane, epoxy resin and/or polyamide.

In all method variants, the matrix material can have at least one polyurethane material.

By the leaf springs in fibre composite construction, a distinct saving of weight can be achieved and thus for example in the field of use of motor vehicles the fuel consumption and hence also the pollutant emission can be reduced. Also, a quieter driving behaviour occurs with leaf springs in fibre composite construction, i.e. the leaf springs damp noises, for example.

A polyurethane material as component of the matrix material improves, for example, the impregnatability of the fibre material and shortens the curing times, i.e. the reaction times. An excellent toughness, achieved through the polyurethane material, has a positive effect on the fatigue behaviour under load.

In all method variants, by means of the injection box within the strand-drawing therefore highly reactive, i.e. very rapidly curing matrix materials or matrix systems can also be used. Rapidly curing matrix materials or matrix systems are, for example, materials which are completely cured in a time between 10 and 15 minutes.

In addition to the method, the problem is solved furthermore by a strand-drawing device for producing leaf springs in fibre composite construction, comprising a fibre supply store with at least one fibre material stored therein, a traction device which is designed to draw the fibre material continuously out of the fibre supply store, an injection box which is designed to continuously impregnate a respective section of the fibre material, drawn by the traction device through the injection box, within an injection chamber of the injection box under a chamber overpressure with at least one matrix material during the strand-drawing of the fibre material, and a heating device which is designed for the at least partial curing of a section of the fibre material strand impregnated with the matrix material, respectively conveyed to the heating device by means of the traction device, and a forming tool which is designed to shape a respective, at least partially cured section of the fibre material strand, impregnated with the matrix material, into a desired shape of the respective leaf spring. The strand-drawing device according to the invention is designed in so far as to carry out one or more of the methods according to the invention.

The traction device can have in general two traction arrangements, which are mounted in a linearly movable manner with respect to one another in the traction direction of the fibre material, so that they can be moved automatically alternately towards one another and away from one another. The traction arrangement moving in traction direction always engages a section of the fibre material and draws the latter in traction direction, wherein the other traction arrangement, moving respectively contrary to the traction direction, releases the fibre material. The fibre material is thus always moved continuously only in traction direction.

The forming tool can consist of one forming tool element or of several forming tool elements. Several forming tool elements can also be arranged at a distinct distance from one another. Between respectively two forming tool elements, which are spaced apart from one another, in particular also other components of the strand-drawing device can be arranged, in particular a heating device, the traction device and/or a separating device. The forming tool can comprise, for example, a first forming tool, which is designed for the formation of the cross-section contour of the fibre material strand. The forming tool can comprise, for example, a second forming tool, which is designed for the formation of the longitudinal contour of the fibre material strand.

In a special embodiment of the method, the section of the fibre material strand, impregnated with the matrix material, which is drawn out from the injection box can be conveyed, before its complete curing, to a forming tool which is designed to give the desired shape of the leaf spring to the section of the fibre material strand, reinforced with the matrix material, which is drawn respectively continuously out of the injection box. When the fibre material strand, which comprises the fibre material and the matrix material, has exited from the injection box, the fibre material strand can be conveyed to a heating device and can be cured there in a desired manner, i.e. either only partially or completely. Before its complete curing, the fibre material strand can, however, be conveyed to a forming tool. The forming tool can be designed to shape the not yet completely cured fibre material strand in its cross-section shape. Alternatively or additionally, a forming tool can be provided, which is designed to shape the not yet completely cured fibre material strand in its longitudinal extent, i.e. in its longitudinal shape.

In a first variant of the method, the section of the fibre material strand, impregnated with the matrix material, which is drawn out from the injection box can be guided continuously through a cavity of the forming tool defining the cross-section configuration of the desired shape of the leaf spring, and subsequently the fibre material strand can be completely cured in the heating device to a straight leaf spring.

In a first embodiment, the forming tool can have a cavity which is designed to define the desired shape of the leaf spring for the section of the fibre material strand, impregnated with the matrix material, which is drawn out continuously from the injection box, with regard to its cross-section configuration, and the strand-drawing device can have here a control device which is designed to control the heating device and the traction device in such a way that the fibre material strand, after its exit from the cavity is completely cured to a straight leaf spring in the heating device.

If only straight leaf springs are to be produced, then a forming tool for shaping the straight leaf springs into curved leaf springs can be dispensed with. This means that a complete curing can already take place after a running through of the cavity setting the cross-section shape of the leaf springs.

In a second variant of the method, the section of the fibre material strand, impregnated with the matrix material, which is drawn out from the injection box, can be guided continuously through a cavity of the forming tool defining the cross-section configuration of the desired shape of the leaf spring, subsequently the fibre material strand can be heated in the heating device to a fibre material strand which is at least partially or completely cured, and subsequently the at least partially or completely cured fibre material strand can be warmed again, and then shaped and/or pressed in a forming tool to a leaf spring having the desired shape.

In a second embodiment, the forming tool can have a cavity which is designed to define the desired shape of the leaf spring for the section of the fibre material strand, impregnated with the matrix material, which is drawn out continuously from the injection box, with regard to its cross-section configuration, and the strand-drawing device can have here a control device which is designed to control the heating device and the traction device in such a way that the at least partially or completely cured fibre material strand, after its exit from the heating device, is warmed again at a warming device and then, in a further forming tool, is shaped and/or pressed to a leaf spring having the desired shape. Accordingly, the matrix material can be, for example, a two-stage curing epoxy resin (so-called “B stage resin”).

If, on the other hand, curved, in particular bent leaf springs are to be produced, then a forming tool for shaping the straight leaf springs into curved leaf springs can not be dispensed with, rather, an additional forming tool is necessary, which is designed to shape the leaf springs in longitudinal extent. In order to guarantee this, depending on the matrix material which is used, a subsequent warming can take place, so that the leaf springs can be shaped in the additional forming tool. This means that either only a partial curing takes place in the heating device or, for example in the case of thermoplastic matrix materials, the fibre material strand, despite previous complete curing, can be at least partially plasticized through a re-warming again.

In a third variant of the method, the section of the fibre material strand, impregnated with the matrix material, which is drawn out from the injection box, can be guided continuously through a cavity of the forming tool defining the cross-section configuration of the desired shape of the leaf spring, subsequently the fibre material strand can be heated in the heating device to an only partially cured fibre material strand, and subsequently the only partially cured fibre material strand can be shaped, free of re-warming, in a forming tool to a leaf spring having the desired shape, wherein, after the shaping, a complete curing takes place of the leaf spring having the desired shape.

In a third embodiment, the forming tool can have a cavity which is designed to define the desired shape of the leaf spring for the section of the fibre material strand, impregnated with the matrix material, which is drawn out continuously from the injection box, with regard to its cross-section configuration, and the strand-drawing device can have here a control device which is designed to control the heating device and the traction device in such a way that the fibre material strand is heated in the heating device to an only partially cured fibre material strand, and subsequently the only partially cured fibre material strand is shaped, free of re-warming, in a further forming tool to a leaf spring having the desired shape, and after the shaping a complete curing takes place of the leaf spring having the desire shape.

In this third embodiment, in particular matrix materials can be processed which at the time of shaping in the additional forming tool have not yet completely reacted. These can be, for example, epoxy resins in the B state, so-called “B-stage epoxy”.

In a fourth variant of the method, the section of the fibre material strand, impregnated with the matrix material, which is drawn out from the injection box, can be guided continuously through a cavity of the forming tool defining the cross-section configuration of the desired shape of the leaf spring, subsequently the fibre material strand can be heated in the heating device to an at least partially or completely cured fibre material strand, and subsequently the only partially cured fibre material strand or the completely cured and re-warmed fibre material strand can be shaped by means of a radius pultrusion method to a leaf spring with a curved desired shape.

In a fourth embodiment, the forming tool can have a cavity which is designed to define the desired shape of the leaf spring for the section of the fibre material strand, impregnated with the matrix material, which is drawn out continuously from the injection box, with regard to its cross-section configuration, and the strand-drawing device can have here a control device which is designed to control the heating device and the traction device in such a way that the fibre material strand is heated in the heating device to an at least partially or completely cured fibre material strand, and subsequently the only partially cured fibre material strand or the completely cured and re-warmed fibre material strand is shaped to a leaf spring with a curved desired shape by means of a radius pultrusion device of the strand-drawing device.

Several example embodiments of the invention are explained in further detail by way of example in the following description with reference to the enclosed schematic figures. Concrete features of this example embodiments, irrespective of in which concrete context they are mentioned, if applicable also considered individually or in other combinations, can represent general features of the invention.

There are shown:

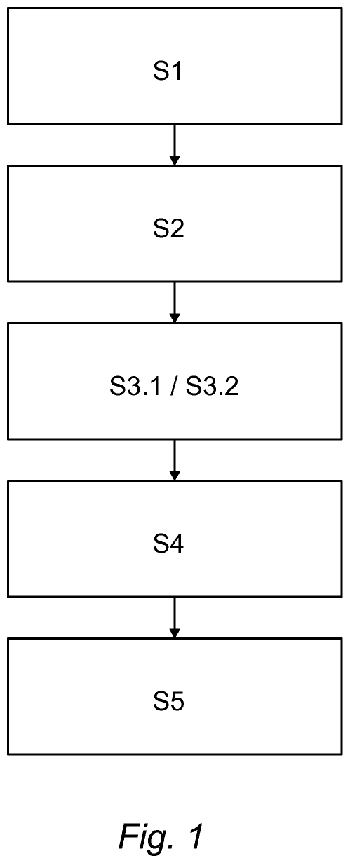

FIG. 1 a flowchart of a basic form of a method according to the invention,

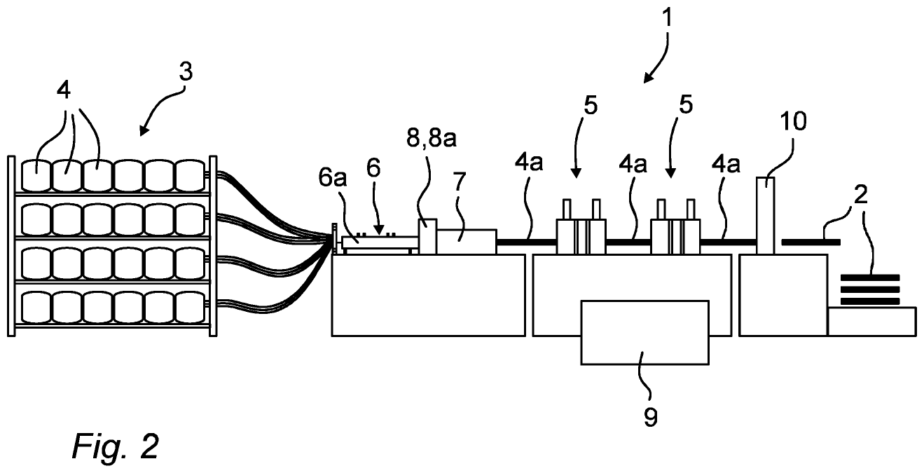

FIG. 2 a schematic illustration of a first variant embodiment of a strand-drawing device according to the invention,

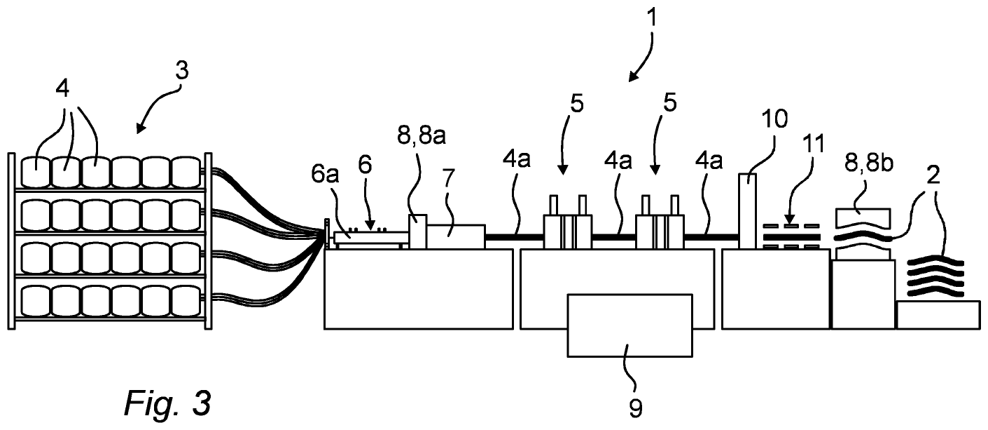

FIG. 3 a schematic illustration of a second variant embodiment of a strand-drawing device according to the invention,

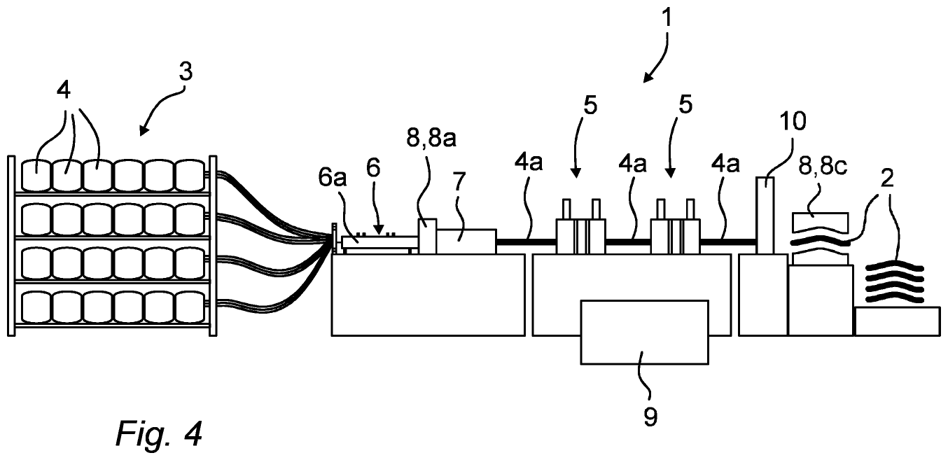

FIG. 4 a schematic illustration of a third variant embodiment of a strand-drawing device according to the invention, and

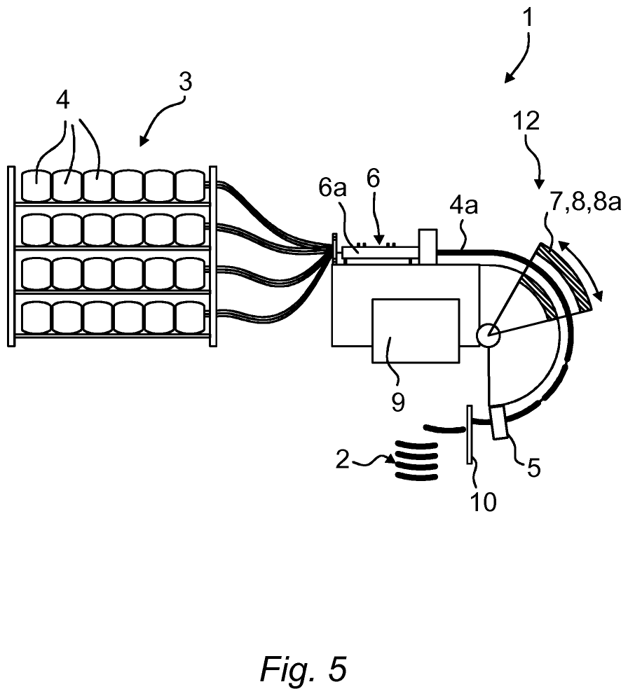

FIG. 5 a schematic illustration of a fourth variant embodiment of a strand-drawing device according to the invention.

In FIG. 1 a basic form of the method according to the invention is shown by means of a flowchart. The method serves for the producing of leaf springs 2 in fibre composite construction into a desired shape of the leaf springs 2, having the first step S1 of strand-drawing of a fibre material 4 out of a fibre supply store 3 into an injection box 6. The injection box 6 is designed to continuously impregnate a respective section of the fibre material 4 in a second step S2 within an injection chamber 6a of the injection box 6 under a chamber overpressure with at least one matrix material during the strand-drawing of the fibre material 4.

In the first part of a third step S3.1, a drawing out takes place of the fibre material strand 4a, impregnated with the matrix material, out of the injection box 6, and subsequently in the second part of a third step S3.2 a conveying of the fibre material strand 4a, impregnated with the matrix material, to a heating device 7.

At the heating device 7, in a fourth step S4 of the method, an at least partial curing of the respective conveyed section of the fibre material strand 7a, impregnated with the matrix material, takes place.

Finally, in a fifth step of the method, a forming of the fibre material strand 4a, reinforced with the matrix material, into the desired shape of the leaf springs 2 takes place.

In FIG. 2 to FIG. 5, various embodiment variants of strand-drawing devices 1 are illustrated. These strand-drawing devices 1 are designed for producing leaf springs 2 in fibre composite construction, having a fibre supply store 3 with at least one fibre material 4 stored therein, a traction device 5, which is designed to draw the fibre material 4 continuously out of the fibre supply store 3, an injection box 6, which is designed to continuously impregnate a respective section of the fibre material 4, which is drawn by the traction device 5 through the injection box 6, within an injection chamber 6a of the injection box 6 under a chamber overpressure with at least one matrix material during the strand-drawing of the fibre material 4, and a heating device 7, which is designed for the at least partial curing of a section of the fibre material strand 4a, impregnated with the matrix material, which is conveyed respectively to the heating device 7 by means of the traction device 5, and a forming tool 8, which is designed to shape a respective, at least partially cured section of the fibre material strand 4a, reinforced with the matrix material, into a desired shape of the respective leaf spring 2.

In the first variant embodiment according to FIG. 2, the forming tool 8 has a cavity 8a, which is designed to define the desired shape of the leaf spring 2 for the section of the fibre material strand 4a, impregnated with the matrix material which is drawn out continuously from the injection box 6, with regard to its cross-section configuration, and the strand-drawing device 1 has a control device 9 which is designed to control the heating device 7 and the traction device 5 in such a way that the fibre material strand 4a, after its exit from the cavity 8a, is completely cured in the heating device 7 to a straight leaf spring 2. After a complete curing, the respective end-side leaf spring 2 can be separated from the fibre material strand 4a by means of a separating device 10a, such as a saw for example.

In the second variant embodiment according to FIG. 3, the forming tool 8 has a cavity 8a which is designed to define the desired shape of the leaf spring 2 for the section of the fibre material strand 4a, impregnated with the matrix material, which is drawn out continuously from the injection box 6, with regard to its cross-section configuration, and the strand-drawing device 1 has a control device 9, which is designed to control the heating device 7 and the traction device 5 in such a way that the at least partially or completely cured fibre material strand 4a, after its exit from the heating device 7, is warmed again at a warming device and is then shaped and/or pressed in a further forming tool 8b to a leaf spring having the desired shape. In the case of the present example embodiment, the warming device 11 is arranged in traction direction after the traction device 5 and after the separating device 10. In corresponding modifications of this second variant embodiment, the warming device 11 can, however, be arranged for example after the traction device 5 and before the separating device 10, i.e. between the traction device 5 and before the separating device 10 or if applicable also even before the traction device 5 and before the separating device 10.

In the third variant embodiment according to FIG. 4, the forming tool 8 has a cavity 8a, which is designed to define the desired shape of the leaf spring 2 for the fibre material strand 4a, impregnated with the matrix material, which is drawn out continuously from the injection box 6, with regard to its cross-section configuration, and the strand-drawing device 1 has a control device 9, which is designed to control the heating device 7 and the traction device 5 in such a way that the fibre material strand 4a is heated in the heating device 7 to an only partially cured fibre material strand 4a, and subsequently the only partially cured fibre material strand 4a is shaped, free of re-warming, to a leaf spring 2 having the desired shape in a further forming tool 8c, and a complete curing of the leaf spring 2, having the desired shape, only takes place after the shaping.

In the fourth variant embodiment according to FIG. 5, the forming tool 8 has a cavity 8a, which is designed to define the desired shape of the leaf spring 2 for the section of the fibre material strand 4a, impregnated with the matrix material, which is drawn out continuously from the injection box 6, with regard to its cross-section configuration, wherein the strand-drawing device 1 has a control device 9 which is designed to control the heating device 7 and the traction device 5 in such a way that the fibre material strand 4a is heated to an at least partially or completely cured fibre material strand 4a in the heating device 7, which is movable on a circular path, and subsequently the only partially cured fibre material strand 4a or the completely cured and re-warmed fibre material strand 4a is shaped to a leaf spring 2 with a curved, in particular circular-arc-shaped, desired shape by means of a radius pultrusion device 12, which moves the heating device 7 together with the forming tool 8 or respectively the cavity 8a.

### LIST OF REFERENCE NUMBERS

1 strand-drawing device
2 leaf springs
3 fibre supply store
4 fibre material
4a fibre material strand
5 traction device
6 injection box
6a injection chamber
7 heating device
8 forming tool
8a cavity
9 control device
10 separating device
11 warming device
12 radius pultrusion device

What is claimed is:

1. A method for producing leaf springs (2) in fibre composite construction into a desired shape of the leaf springs (2), comprising the steps:
strand-drawing a fibre material (4) from a fibre supply store (3) into an injection box (6), which is designed to continuously impregnate a respective section of the fibre material (4) within an injection chamber (6a) of the injection box (6) under a chamber overpressure with at least one matrix material during the strand-drawing of the fibre material (4), wherein the matrix material is injected from outside the injection box (6) into the injection chamber (6a) or is pressed in with pressure,
drawing the fibre material strand (4a) impregnated with the matrix material out of the injection box (6), and subsequently, conveying the fibre material strand (4a) impregnated with matrix material to a heating device (7), where the respective conveyed section of the fibre material strand (4a) impregnated with the matrix material is at least partially cured, and forming the fibre material strand (4a) reinforced with the matrix material into the desired shape of the leaf springs (2).

2. The method according to claim 1,
wherein the section, drawn out of the injection box (6), of the fibre material strand (4a) impregnated with the matrix material is conveyed before its complete curing to a forming tool (8) which is designed to give the desired shape of the leaf spring (2) to the section of the fibre material strand (4a), reinforced with the matrix material, which is respectively drawn continuously out of the injection box (6).

3. The method according to claim 2,
wherein the section of the fibre material strand (4a), impregnated with the matrix material, which is drawn out of the injection box (6) is drawn continuously through a cavity (8a) of the forming tool (8) defining the cross-section configuration of the desired shape of the leaf spring (2), and subsequently the fibre material strand (4a) is completely cured to a straight leaf spring (2) in the heating device (7).

4. The method according to claim 2,
wherein the section of the material strand (4a), impregnated with the matrix material, which is drawn out from the injection box (6) is drawn continuously through a cavity (8a) of the forming tool (8) defining a cross-section configuration of the desired shape of the leaf spring (2), subsequently the fibre material strand (4a) is heated in the heating device (7) to an at least partially or completely cured fibre material strand (4a) and subsequently the at least partially or completely cured fibre material strand (4a) is warmed again and is then shaped and/or pressed in a forming tool (8b) to a leaf spring (2) having the desired shape.

5. The method according to claim 2,
wherein the section of the fibre material strand (4a), impregnated with the matrix material, which is drawn out from the injection box (6) is drawn continuously through a cavity (8a) of the forming tool (8) defining the cross-section configuration of the desired shape of the leaf spring (2), subsequently the fibre material strand (4a) is heated in the heating device (7) to an only partially cured fibre material strand (4a), and subsequently the only partially cured fibre material strand (4a) is shaped, free of re-warming, in a forming tool (8c) to a leaf spring (2) having the desired shape and, after the shaping, a complete curing of the leaf spring (2) having the desired shape takes place.

6. The method according to claim 2,
wherein the section of the fibre material strand (4a), impregnated with the matrix material, which is drawn out of the injection box (6), is drawn continuously through a cavity (8a) of the forming tool (8) defining the cross-section configuration of the desired shape of the leaf spring (2), subsequently the fibre material strand (4a) is heated in the heating device (7) to an at least partially or completely cured fibre material strand (4a), and subsequently the only partially cured fibre material strand (4a) or the completely cured and re-warmed fibre material strand is shaped by means of a radius pultrusion method to a leaf spring (2) with a curved desired shape.

7. The method according to claim 1,
wherein the matrix material comprises at least one polyurethane material or a two-stage curing epoxy resin.

8. A strand-drawing device for producing leaf springs (2) in fibre composite construction, having a fibre supply store (3) with at least one fibre material stored therein, a traction device (5) which is designed to draw the fibre material continuously out of the fibre supply store (3), an injection box (6) which is designed to continuously impregnate a respective section of the fibre material, drawn through the injection box (6) by the traction device (5), within an injection chamber (6a) of the injection box (6) under a chamber overpressure, with at least one matrix material injected from outside the injection box (6) into the injection chamber (6a) or pressed in under pressure during the strand-drawing of the fibre material (4), and a heating device (7) which is designed for the at least partial curing of a section of the fibre material strand (4a), impregnated with the matrix material, respectively conveyed to the heating device (7) by means of the traction device (5), and a forming tool (8) which is designed to shape a respective at least partially cured section of the fibre material strand (4a), reinforced with the matrix material, into a desired shape of the respective leaf spring (2).

9. The strand-drawing device according to claim 8,
wherein the forming tool (8) has a cavity (8a) which is designed to define the desired shape of the leaf spring (2) for the section of the fibre material strand (4a), impregnated with the matrix material, drawn continuously out of the injection box (6), with regard to its cross-section configuration, and the strand-drawing device (1) has a control device (9) which is designed to control the heating device (7) and the traction device (5) in such a way that the fibre material strand (4a), after its exit from the cavity (8a), is cured completely to a straight leaf spring (2) in the heating device (7).

10. The strand-drawing device according to claim 8,
wherein the forming tool (8) has a cavity (8a) which is designed to define the desired shape of the leaf spring (2) for the section of the fibre material strand (4a), impregnated with the matrix material, which is drawn continuously out of the injection box (6), with regard to its cross-section configuration, and the strand-drawing device (1) has a control device (9) which is designed to control the heating device (7) and the traction device (5) in such a way that the at least partially or completely cured fibre material strand (4a), after its exit from the heating device (7), is warmed again at a warming device (11) and then in a further forming tool (8b) is shaped and/or pressed to a leaf spring (2) having the desired shape.

11. The strand-drawing device according to claim 8,
wherein the forming tool (8) has a cavity (8a) which is designed to define the desired shape of the leaf spring (2) for the section of the fibre material strand (4a), impregnated with the matrix material, which is drawn continuously out of the injection box (6), with regard to its cross-section configuration, and the strand-drawing device (1) has a control device (9) which is designed to control the heating device (7) and the traction device (5) in such a way that the fibre material strand (4a) is heated in the heating device (7) to an only partially cured fibre material strand (4a), and subsequently the only partially cured fibre material strand (4a) is shaped, free of re-warming, in a further forming tool (8c) to a leaf spring (2) having the desired shape and, after the shaping, a complete curing of the leaf spring (2) having the desired shape takes place.

12. The strand-drawing device according to claim 8,
wherein the forming tool (8) has a cavity (8a) which is designed to define the desired shape of the leaf spring (2) for the section of the fibre material strand (4a), impregnated with the matrix material, which is drawn continuously out of the injection box (6), with regard to its cross-section configuration, and the strand-drawing device (1) has a control device (9) which is designed to control the heating device (7) and the traction device (5) in such a way that the fibre material strand (4a) is heated in the heating device (7) to an at least partially or completely cured fibre material strand (4a), and subsequently the only partially cured fibre material strand (4a) or the completely cured and re-warmed fibre material strand (4a) is shaped by means of a radius-pultrusion device (12) of the strand-drawing device (1) to a leaf spring (2) with a curved desired shape.
